(19) United States
(12) Patent Application Publication
(10) Pub. No.: US 2026/0151741 A1
(43) Pub. Date: Jun. 4, 2026

(54) PTFE MEMBRANE, MANUFACTURING METHOD THEREOF, AND FILTER

(71) Applicant: KOMEMTEC CO,.LTD., Yeonggwang-gun (KR)

(72) Inventors: SUNG CHUL KIM, Yeonggwang-gun (KR); MYEONG JUN JANG, Yeonggwang-gun (KR); DONG SIK HAM, Yeonggwang-gun (KR)

(21) Appl. No.: 18/967,840

(22) Filed: Dec. 4, 2024

(51) Int. Cl. B01D 67/00; B01D 46/52; B01D 69/02; B01D 71/36

(52) U.S. Cl. CPC B01D 67/0004; B01D 46/521; B01D 69/02; B01D 71/36; B01D 2323/12; B01D 2323/2182; B01D 2325/02834

(57) ABSTRACT

The present invention provides a method for manufacturing a PTFE membrane, comprising the steps of: manufacturing a PTFE composition including first PTFE particles, second PTFE particles, and an additive; extruding the PTFE composition to manufacture a PTFE sheet; and stretching the PTFE sheet. The present invention also provides a PTFE membrane and a filter.

### BACKGROUND

### 1. Technical Field

The present invention relates to a PTFE membrane, manufacturing method thereof, and filter.

### 2. Description of the Related Art

A porous filter using polytetrafluoroethylene (PTFE) has characteristics such as high heat resistance, chemical stability, weather resistance, incombustibility, high strength, non-adhesiveness, and a low friction coefficient of PTFE, and characteristics such as flexibility, dispersion medium permeability, particle capturing properties, and a low dielectric constant due to porosity. Therefore, porous filters made of PTFE are widely used as microfiltration filters for dispersion media and gases in semiconductor-related fields, liquid-crystal-related fields, and food-medical-related fields.

Porous PTFE membranes are generally produced as follows. A mixture obtained by mixing a PTFE fine powder and a liquid lubricant serving as an extrusion aid is extrusion-molded, and the resulting molded body is rolled to form a PTFE sheet. The liquid lubricant is removed from the PTFE sheet, and then the resulting PTFE sheet, from which the liquid lubricant has been removed, is stretched to make the sheet porous. Thus, a porous PTFE membrane is produced. The porous PTFE membrane thus obtained has a porous structure of nodes and fibrils, as is well known.

When the porous PTFE membrane is used as a collection layer of a filter medium, it is usually bonded to an air-permeable support member such as a nonwoven fabric to provide the required strength to the membrane. The porous PTFE membrane and the air-permeable support member are bonded together by heat lamination, lamination using an adhesive (adhesive lamination), or the like.

FIG. 1 is a diagram showing the microstructure of a conventional node-type PTFE membrane and a star-type PTFE membrane. As shown, the node-type PTFE membrane has the advantage of good air permeability but has the disadvantages of low tensile strength and low tissue uniformity. On the other hand, the star-type PTFE membrane has the advantages of good tensile strength and tissue uniformity but has the disadvantage of low air permeability.

In order to apply PTFE membranes to HEPA filters and ULPA filters, they must have excellent tissue uniformity, tensile strength, porosity, and pore size. However, conventional PTFE membranes have a problem in that they do not satisfy the above performances.

### SUMMARY

The objective of the present invention is to provide a PTFE membrane having excellent tissue uniformity, tensile strength, porosity and pore size, and a method for manufacturing the same.

In addition, the objective of the present invention is to provide a high-performance filter medium, filter pack and filter unit.

However, the objectives of the present invention are not limited to the objectives mentioned above, and other objectives not mentioned will be clearly understood by those skilled in the art from the following description.

To address the above challenges, in one aspect, the present invention provides a method for manufacturing a PTFE membrane, comprising the steps of: manufacturing a PTFE composition including first PTFE particles, second PTFE particles, and an additive; extruding the PTFE composition to manufacture a PTFE sheet; and stretching the PTFE sheet.

In addition, the present invention provides a method for manufacturing a PTFE membrane, wherein the first PTFE particles and the second PTFE particles have different heats of melting.

In addition, the present invention provides a method for manufacturing a PTFE membrane, wherein the mixing weight ratio of the first PTFE particles and the second PTFE particles is within a range of 6:4 to 2:8.

In addition, the present invention provides a method for manufacturing a PTFE membrane, wherein the mixing weight ratio of the first PTFE particles and the second PTFE particles is within a range of 5:5 to 3:7.

In addition, the present invention provides a method for manufacturing a PTFE membrane, wherein the heat of melting of the first PTFE particles, calculated through DSC analysis under a heating rate condition of 10° C./min, is within a range of 60 to 70 J/g, and the heat of melting of the second PTFE particles is within a range of 50 to 60 J/g.

In addition, a method for manufacturing a PTFE membrane is provided, wherein the heat of melting of the first PTFE particles is in the range of 61 to 66 J/g, and the heat of melting of the second PTFE particles is in the range of 52 to 58 J/g.

In addition, a method for manufacturing a PTFE membrane is provided, wherein the difference in melting temperature between the first PTFE particle and the second PTFE particle is 2.0° C. or less.

In addition, a method for manufacturing a PTFE membrane is provided, wherein the difference in melting temperature between the first PTFE particle and the second PTFE particle is 1.0° C. or less.

In addition, a method for manufacturing a PTFE membrane is provided, wherein the additive is hydrocarbons mixture solution and the molar ratio of hydrocarbon having 9 to 10 carbon atoms and hydrocarbon having 10 to 13 carbon atoms is within the range of 8:2 to 6:4.

In addition, a method for manufacturing a PTFE membrane is provided, wherein the additive is included in an amount of 10 to 30 wt % of the PTFE composition.

In addition, the present invention provides a PTFE membrane manufactured by the above manufacturing method.

In addition, the present invention provides a PTFE membrane having a pore size in the range of 0.2 to 0.5 μm and a porosity in the range of 70 to 90%.

In addition, the present invention provides a filter medium comprising the PTFE membrane and an air-permeable support member laminated on the PTFE membrane.

In addition, the present invention provides a filter pack comprising a pleated filter medium.

In addition, the present invention provides a filter unit comprising the filter pack and a frame that supports a periphery of the filter pack.

The PTFE membrane according to the present invention has excellent uniformity of tissue, tensile strength, porosity and pore size, and can be usefully used in high-performance filter medium, filter packs and filter units.

The above effects and additional effects will be described in detail below.

### BRIEF DESCRIPTION OF THE DRAWINGS

FIG. 1 is a photograph showing a conventional PTFE membrane microstructure,

FIG. 2 is a photograph showing a PTFE membrane microstructure according to an embodiment of the present invention,

FIG. 3 is a schematic diagram of a filter unit, and

FIG. 4 and FIG. 5 are diagrams showing DSC analysis results of first PTFE particles and second PTFE particles according to an embodiment of the present invention.

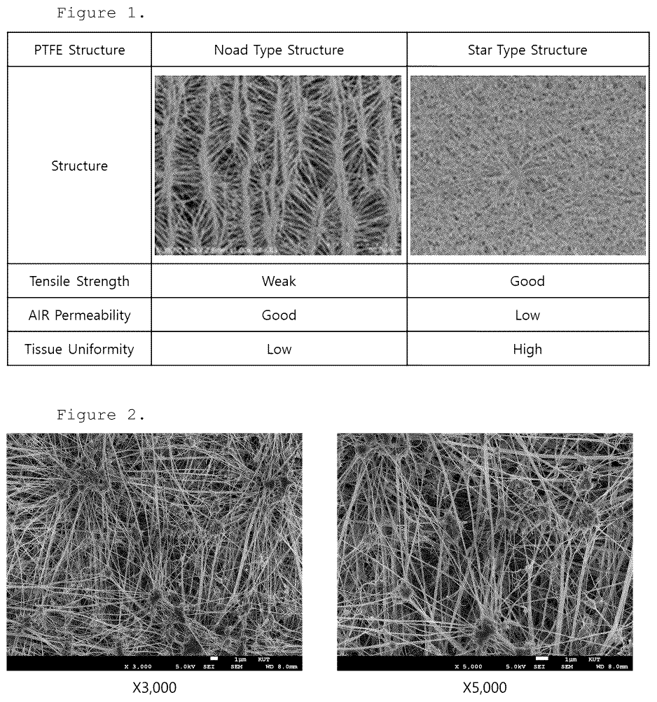

### EXPLANATION OF DRAWING SYMBOLS

1: Filter medium
2: Frame
10: Filter unit

### DETAILED DESCRIPTION

Before describing the present invention in detail below, it should be understood that the terms used in the present specification are intended to describe specific embodiments and are not intended to limit the scope of the present invention, which is limited only by the scope of the attached patent claims. All technical and scientific terms used in the present specification have the same meaning as those generally understood by those skilled in the art unless otherwise stated.

Throughout this specification and claims, the term “comprise, comprises, comprising” means including the mentioned object, step or group of objects, and is not used to exclude any other object, step or group of objects or group of steps, unless otherwise stated.

Meanwhile, various embodiments of the present invention may be combined with any other embodiments unless there is a clear contrary point. Any feature that is indicated as being particularly desirable or advantageous may be combined with other features.

Hereinafter, the present invention will be described in more detail.

A method for manufacturing a PTFE membrane according to one embodiment of the present invention comprises the steps of: manufacturing a PTFE composition including first PTFE particles, second PTFE particles, and an additive; extruding the PTFE composition to manufacture a PTFE sheet; and stretching the PTFE sheet. The PTFE composition may further include other components and may further include other types of PTFE particles.

The first PTFE particles and the second PTFE particles are particles having different characteristics and may have different heats of melting. Specifically, the heat of melting of the first PTFE particles may be greater than the heat of melting of the second PTFE particles.

FIG. 2 is a photograph illustrating the microstructure of a PTFE membrane according to one embodiment of the present invention, which has a structure in which star types and node types coexist.

Based on the results of the examples described below, it is thought that the first PTFE particle with high heat of melting has high crystallinity and thus has excellent uniformity of structure and tensile strength, which are advantages of a star-type microstructure, and the second PTFE particle with low heat of melting has low crystallinity and thus has excellent porosity and air permeability, which are advantages of a node-type microstructure.

Specifically, the heat of melting of the first PTFE particles, which is calculated by DSC analysis under a heating rate condition of 10° C./min, is in the range of 60 to 70 J/g, and the heat of melting of the second PTFE particles may be in the range of 50 to 60 J/g. More specifically, the heat of melting of the first PTFE particles may be in the range of 61 to 66 J/g, and the heat of melting of the second PTFE particles may be in the range of 52 to 58 J/g. Within the above ranges, the uniformity of the tissue, tensile strength, porosity, and pore size can be excellent.

In addition, the difference in melting temperatures between the first PTFE particles and the second PTFE particles may be 2.0° C. or less. Specifically, the difference in melting temperatures between the first PTFE particles and the second PTFE particles may be 1.0° C. or less. By making the melting temperatures of the two PTFE particles similar, the uniformity of the tissue and the tensile strength can be improved.

The average particle diameter of the first PTFE particles and the second PTFE particles is not limited but may be within a range of 400 to 600 μm. Specifically, the first PTFE particles may be within a range of 500 to 600 μm, and the second PTFE particles may be within a range of 400 to 500 μm.

The above additive is a hydrocarbon mixture solution having an iso (ISO) structure, and the concentration ratio of isohydrocarbon having 9 to 11 carbon atoms and isohydrocarbon having 10 to 13 carbon atoms can be in the range of 8:2 to 6:4. Within the above range, the shear viscosity can be lowered, thereby improving the membrane forming property, and the tensile strength in both the MD direction and the TD direction can be improved, and it can have a high density and improve the filter performance.

The above additive may be included in an amount of 10 to 30 wt % of the PTFE composition.

In the method for manufacturing a PTFE membrane, any known method other than those described above may be used and is not limited thereto. As an example of a method for manufacturing a PTFE membrane, a PTFE composition may be manufactured by mixing PTFE powder and an additive, and then the PTFE composition may be extruded and molded to manufacture a PTFE sheet.

Specifically, the PTFE composition may be first molded to obtain a preform, the preform may be extruded to obtain a rod-shaped first molded body, and the first molded body may be processed into a sheet shape to obtain a second molded body. Thereafter, the second molded body may be dried to remove the additive, and then the second molded body may be stretched in the MD direction and the TD direction.

The above PTFE composition may be aged for a period ranging from 1 hour to 80 hours. The stretching step may first perform an MD direction stretching process to stretch 3 to 6 times in a temperature range of 200 to 400° C., and then stretch 12 to 20 times in a TD direction in a temperature range of 100 to 450° C.

Afterwards, the membrane properties such as pore size, porosity, and thickness of the PTFE membrane can be stabilized through a heat treatment process.

A PTFE membrane manufactured by a method for manufacturing a PTFE membrane according to an embodiment of the present invention has a pore size of 0.2 to 0.5 μm, specifically 0.25 to 0.40 μm, as shown in the examples described below, and a porosity of 70 to 90%, specifically 75 to 85, and can be usefully used in high-performance filters such as a HEPA filter and an ULPA filter. The structure of the filter is not limited and can be used in known filters.

In order to use the obtained porous PTFE membrane as a filter medium, it is desirable to laminate the membrane with an air-permeable support member. This laminating step may be performed by bonding the porous PTFE membrane and the air-permeable support member together by a conventionally used method.

Preferably, the fibers constituting the air-permeable support member are made of a thermoplastic resin, specifically polyolefin (for example, polyethylene (PE) or polypropylene (PP)), polyester (for example, polyethylene terephthalate (PET)), polyamide, or a composite material of these.

As the air-permeable support member, woven fabric, nonwoven fabric, felt, or the like can be used, but nonwoven fabric is often used. A typical nonwoven fabric known as a preferable air-permeable support member is made of conjugated fibers having a core-sheath structure in which the melting point of the core component (for example, PET) is higher than that of the sheath component (for example, PE). This nonwoven fabric is suitable for heat lamination in which the sheath component is melted and bonded with the porous PTFE membrane.

A lower limit of the average thickness of air-permeable support member is preferably 0.1 mm, and more preferably 0.2 mm. On the other hand, an upper limit of the average thickness of air-permeable support member is preferably 0.5 mm, and more preferably 0.4 mm.

Furthermore, from the viewpoint of achieving both the mechanical strength of air-permeable support member and the filtration rate of filter medium, the average thickness is preferably from 0.1 mm to 0.5 mm, more preferably from 0.2 mm to 0.4 mm. When the average thickness is less than the lower limit, the mechanical strength of air-permeable support member may be insufficient. On the other hand, when the average thickness exceeds the upper limit, filter medium becomes unnecessarily thick, and there is a possibility that the pressure loss during permeation of the filtrate increases.

A lower limit of the mean pore size of air-permeable support member is preferably 0.5 μm, and more preferably 1 μm. On the other hand, an upper limit of the mean pore size is preferably 5 μm, and more preferably 3 μm. When the mean pore size of air-permeable support member is less than the lower limit, the pressure loss of filter medium may increase. On the other hand, when the mean pore size of filter medium exceeds the upper limit, the strength of air-permeable support member may be insufficient.

Air-permeable support member may contain other resins and additives as long as they do not adversely affect the desired effects of the present disclosure. Examples of the additives include pigments for coloring, inorganic fillers for improving abrasion resistance, preventing low-temperature flow, and facilitating pore formation, metal powders, metal oxide powders, and metal sulfide powders.

The lamination of the porous PTFE membrane and the air-permeable support member can also be performed not only by the above-mentioned heat lamination but also by adhesive lamination or the like. In adhesive lamination, it is appropriate to use a hot melt type adhesive, for example.

The layered structure of the porous PTFE membrane and the air-permeable support member is not particularly limited, but it is preferably a structure in which at least one air-permeable support member is disposed on each of the surfaces of the porous PTFE membrane (typically, a three-layer structure including an air-permeable support member, a porous PTFE membrane, and an air-permeable support member in this order). However, the layered structure may be a structure including two porous PTFE membranes (for example, a five-layer structure including an air-permeable support member, a porous PTFE membrane, an aid-permeable support member, a porous PTFE membrane, and an air-permeable support member in this order), if required. It is also possible to use a structure including an air-permeable support member with a small diameter as a pre-filter (for example, a four-layer structure including an air-permeable support member (pre-filter), an air-permeable support member, a PTFE membrane, and an air-permeable support member in this order from the upstream side of the airflow) in some applications.

Filter media are usually subjected to pleating by a known technique. Pleating is performed by folding a filter medium along mountain folds and valley folds that are formed alternately and in parallel to each other on the surface of the filter medium into an accordion shape (a continuous W shape), for example, using a reciprocating pleating machine. The pleated filter medium is sometimes referred to as a filter pack. A spacer may be disposed in the filter pack to maintain the pleated shape. As the spacer, a resin cord called a bead is often used. A bead is disposed on the filter medium in a direction perpendicular to the mountain folds (valley folds) (in a direction going up the mountains and down the valleys). Preferably, a plurality of beads that are evenly spaced apart from each other are disposed on the filter medium so that they extend in this direction. Preferably, the beads are disposed on both the front and back surfaces of the filter medium. Typically, the beads are formed by melting resin such as polyamide or polyolefin and applying molten resin.

The periphery of the pleated filter medium (filter pack) is supported by a frame (supporting frame), if necessary. Thus, a filter unit is obtained. As the frame, a metal or resin member is used for the intended purpose, such as for use in a filter. When a resin frame is used, a filter medium may be fixed to the frame while forming the frame by injection molding. FIG. 3 shows an example of a filter unit. A filter unit 10 includes a pleated filter medium 1 and a frame 2 for fixing the outer periphery of the filter medium 1.

Hereinafter, the present invention will be described in more detail based on embodiments. Furthermore, the scope of the present invention is not limited to the following embodiments.

### Manufacturing Example 1-1: Manufacturing of PTFE Composition A

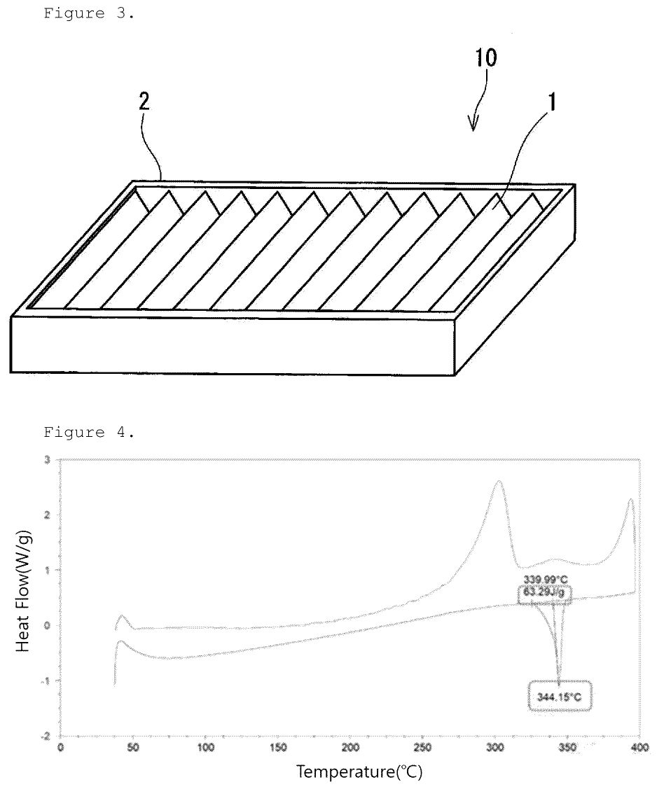

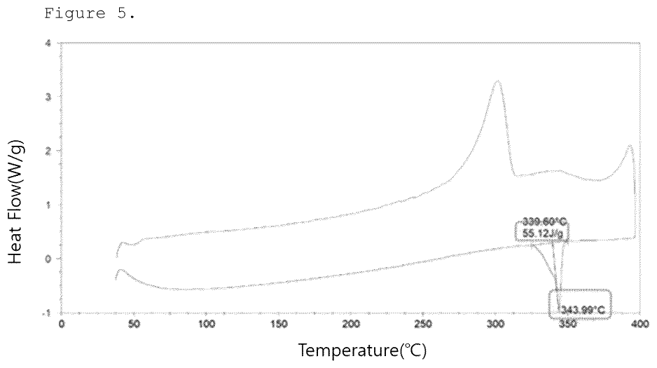

As the first PTFE particle, PTFE having a heat of melting of 63.29 J/g and a melting temperature of 344.15° C., as calculated by DSC analysis under a heating rate condition of 10° C./min, was used (FIG. 4), and as the second PTFE particle, PTFE having a heat of melting of 55.12 J/g and a melting temperature of 343.99° C. was used (FIG. 5).

As an additive, an isohydrocarbon mixture solution with a concentration ratio of 7:3 of isohydrocarbons having 9 to 11 carbon atoms and isohydrocarbons having 10 to 13 carbon atoms was used.

First PTFE particles and second PTFE particles were mixed at a weight ratio of 3:7, and 20 wt % of an additive was added to prepare a PTFE composition. Thereafter, the PTFE composition was aged for 24 hours.

### Manufacturing Example 1-2: Manufacturing of PTFE Composition B

The same procedure as Manufacturing Example 1-1 was followed, except that the mixing ratio of the first PTFE particles and the second PTFE particles was set to 4:6.

### Manufacturing Example 1-3: Manufacturing of PTFE Composition C

The same procedure as Manufacturing Example 1-1 was followed, except that the mixing ratio of the first PTFE particles and the second PTFE particles was set to 5:5.

### Manufacturing Example 1-4: Manufacturing of PTFE Composition D

The same procedure as Manufacturing Example 1-1 was followed, except that the mixing ratio of the first PTFE particles and the second PTFE particles was set to 6:4.

### Manufacturing Example 1-5: Manufacturing of PTFE Composition E

The same procedure as Manufacturing Example 1-1 was followed, except that the mixing ratio of the first PTFE particles and the second PTFE particles was set to 7:3.

### Manufacturing Example 1-6: Manufacturing of PTFE Composition F

The same procedure as Manufacturing Example 1-1 was followed, except that only the first PTFE particles were used.

### Manufacturing Example 1-7: Manufacturing of PTFE Composition G

The same procedure as Manufacturing Example 1-1 was followed, except that only the second PTFE particles were used.

### Manufacturing Example 1-8: Manufacturing of PTFE Composition H

The same procedure as in Manufacturing Example 1-1 was followed, except that PTFE having a heat of melting of 71.34 J/g was used as the first PTFE particle, and PTFE having a heat of melting of 62.65 J/g was used as the second PTFE particle.

### Manufacturing Example 1-9: Manufacturing of PTFE Composition I

The same procedure as in Manufacturing Example 1-1 was followed, except that PTFE having a heat of melting of 58.13 J/g was used as the first PTFE particle, and PTFE having a heat of melting of 48.18 J/g was used as the second PTFE particle.

### Manufacturing Example 2-1: Manufacturing of PTFE Membrane A

PTFE composition A manufactured in Manufacturing Example 1-1 was pressurized to manufacture a PTFE billet, processed into a cord having a diameter of 22 mm using extrusion equipment, and manufactured in the form of a sheet having a width of 20 cm in a subsequent step. The sheet was stretched 600% in the MD stretching process and stretched to a width of 2400 mm in the CMD (TD) process, and then subjected to a heat treatment process.

### Manufacturing Example 2-2: Manufacturing of PTFE Membrane B

PTFE membrane B was manufactured in the same manner as in Manufacturing Example 2-1, except that PTFE composition B manufactured in Manufacturing Example 1-2 was used instead of PTFE composition A.

### Manufacturing Example 2-3: Manufacturing of PTFE Membrane C

PTFE membrane C was manufactured in the same manner as in Manufacturing Example 2-1, except that PTFE composition C manufactured in Manufacturing Example 1-3 was used instead of PTFE composition A.

### Manufacturing Example 2-4: Manufacturing of PTFE Membrane D

PTFE membrane D was manufactured in the same manner as in Manufacturing Example 2-1, except that PTFE composition D manufactured in Manufacturing Example 1-4 was used instead of PTFE composition A. An SEM image of the manufactured PTFE membrane is shown in FIG. 2. As shown, it can be confirmed that the node type and the star type coexist.

### Manufacturing Example 2-5: Manufacturing of PTFE Membrane E

PTFE membrane E was manufactured in the same manner as in Manufacturing Example 2-1, except that PTFE composition E manufactured in Manufacturing Example 1-5 was used instead of PTFE composition A.

### Manufacturing Example 2-6: Manufacturing of PTFE Membrane F

PTFE membrane F was manufactured in the same manner as in Manufacturing Example 2-1, except that PTFE composition F manufactured in Manufacturing Example 1-6 was used instead of PTFE composition A.

### Manufacturing Example 2-7: Manufacturing of PTFE Membrane G

PTFE membrane G was manufactured in the same manner as in Manufacturing Example 2-1, except that PTFE composition G manufactured in Manufacturing Example 1-7 was used instead of PTFE composition A.

### Manufacturing Example 2-8: Manufacturing of PTFE Membrane H

PTFE membrane H was manufactured in the same manner as in Manufacturing Example 2-1, except that PTFE composition H manufactured in Manufacturing Example 1-8 was used instead of PTFE composition A.

### Manufacturing Example 2-9: Manufacturing of PTFE Membrane I

PTFE membrane I was manufactured in the same manner as in Manufacturing Example 2-1, except that PTFE composition I manufactured in Manufacturing Example 1-9 was used instead of PTFE composition A.

### Experimental Example 1: Pore Size Measurement

The PTFE membrane manufactured in the manufacturing example was evaluated based on ASTM F 316, and the results are shown in Table 1.

### Experimental Example 2: Porosity Measurement

The PTFE membrane manufactured in the manufacturing example was evaluated based on ISO 15901, and the results are shown in Table 1.

### Experimental Example 3: Tensile Strength Measurement

The PTFE membranes manufactured in the manufacturing examples were evaluated for TD tensile strength and MD tensile strength based on ASTM D882. The tensile strength values of Manufacturing Examples 2-2 to 2-9 were expressed as a ratio based on 100 of the tensile strength value of Manufacturing Example 2-1.

TABLE 1

| Manufacturing | Pore | Porosity | TD tensile | MD tensile |
|---|---|---|---|---|
| Example | Size (μm) | (%) | strength | strength |
| Manufacturing | 0.53 | 78.93 | 100 | 100 |
| Example 2-1 | | | | |
| Manufacturing | 0.46 | 77.11 | 105 | 106 |
| Example 2-2 | | | | |
| Manufacturing | 0.43 | 76.64 | 114 | 121 |
| Example 2-3 | | | | |
| Manufacturing | 0.37 | 75.78 | 134 | 168 |
| Example 2-4 | | | | |
| Manufacturing | 0.34 | 72.58 | 139 | 182 |
| Example 2-5 | | | | |
| Manufacturing | 0.26 | 65.93 | 141 | 178 |
| Example 2-6 | | | | |
| Manufacturing | 0.94 | 79.12 | 79 | 86 |
| Example 2-7 | | | | |
| Manufacturing | 0.23 | 68.83 | 143 | 179 |
| Example 2-8 | | | | |
| Manufacturing | 0.87 | 78.65 | 82 | 66 |
| Example 2-9 | | | | |

As shown in the results in Table 1, it can be confirmed that the PTFE membrane according to one embodiment of the present invention is excellent in pore size, porosity, and tensile strength. In particular, the performances of Manufacturing Examples 2-4 and 2-5 were comprehensively the best.

Manufacturing Examples 2-6 and 2-8 had too low a porosity, and Manufacturing Examples 2-7 and 2-9 had too low a tensile strength, making them unsuitable for high-performance filters.

### Manufacturing Example 3-1: Manufacturing of Filter Medium A

A PE/PET nonwoven fabric was heat-bonded to one side of the PTFE membrane A manufactured in the above Manufacturing Example 2-1 at a temperature of 140 to 200° C. Thereafter, a PE/PET nonwoven fabric was heat-bonded to the other side of the PTFE membrane A at a temperature of 170 to 200° C. to manufacture a filter medium A.

### Manufacturing Example 3-2: Manufacturing of Filter Medium B

Filter medium B was manufactured in the same manner as in Manufacturing Example 3-1 above, except that PTFE membrane B was used instead of PTFE membrane A.

### Manufacturing Example 3-3: Manufacturing of Filter Medium C

Filter medium C was manufactured in the same manner as in Manufacturing Example 3-1 above, except that PTFE membrane C was used instead of PTFE membrane A.

### Manufacturing Example 3-4: Manufacturing of Filter Medium D

Filter medium D was manufactured in the same manner as in Manufacturing Example 3-1 above, except that PTFE membrane D was used instead of PTFE membrane A.

### Manufacturing Example 3-5: Manufacturing of Filter Medium E

Filter medium E was manufactured in the same manner as in Manufacturing Example 3-1 above, except that PTFE membrane E was used instead of PTFE membrane A.

### Manufacturing Example 3-6: Manufacturing of Filter Medium F

Filter medium F was manufactured in the same manner as in Manufacturing Example 3-1 above, except that PTFE membrane F was used instead of PTFE membrane A.

### Manufacturing Example 3-7: Manufacturing of Filter Medium G

Filter medium G was manufactured in the same manner as in Manufacturing Example 3-1 above, except that PTFE membrane G was used instead of PTFE membrane A.

### Manufacturing Example 3-8: Manufacturing of Filter Medium H

Filter medium H was manufactured in the same manner as in Manufacturing Example 3-1 above, except that PTFE membrane H was used instead of PTFE membrane A.

### Manufacturing Example 3-9: Manufacturing of Filter Medium I

Filter medium I was manufactured in the same manner as in Manufacturing Example 3-1 above, except that PTFE membrane I was used instead of PTFE membrane A.

### Experimental Example 3: Differential Pressure and Efficiency Measurement

The filter medium manufactured in Manufacturing Examples 3-1 to 3-9 were prepared in a size of 200*200 mm and measured according to the Modified BS EN 1822-3, ISO 29463-3 standard, and the results are shown in Table 2.

TABLE 2

| | Differential | Efficiency |
|---|---|---|
| Manufacturing Example | pressure(mmH₂O) | (%) |
| Manufacturing Example 3-1 | 14.549 | 99.972238 |
| Manufacturing Example 3-2 | 15.133 | 99.984684 |
| Manufacturing Example 3-3 | 18.549 | 99.998743 |
| Manufacturing Example 3-4 | 23.809 | 99.999559 |
| Manufacturing Example 3-5 | 26.157 | 99.999986 |
| Manufacturing Example 3-6 | 49.259 | 99.999832 |
| Manufacturing Example 3-7 | 7.341 | 97.395749 |
| Manufacturing Example 3-8 | 48.072 | 99.999914 |
| Manufacturing Example 3-9 | 9.408 | 98.139056 |

As can be seen from the results in Table 2, it can be confirmed that the filter media according to one embodiment of the present invention has excellent differential pressure and efficiency, and in particular, it can be confirmed that it can be suitably applied to HEPA filters and ULPA filters in the case of Manufacturing Examples 3-4 and 3-5. In the case of Manufacturing Examples 3-6 and 3-8, the differential pressure is too high, and in the case of Manufacturing Examples 3-7 and 3-9, the efficiency is too low, so there is a problem with performance.

What is claimed is:

1. A method for manufacturing a PTFE membrane, comprising the steps of:
producing a PTFE composition comprising first PTFE particles, second PTFE particles, and an additive;
extruding the PTFE composition to form a PTFE sheet; and stretching the PTFE sheet.

2. The method for manufacturing a PTFE membrane of claim 1, wherein the first PTFE particles and the second PTFE particles have different melting heats.

3. The method for manufacturing a PTFE membrane of claim 2, wherein the mixing weight ratio of the first PTFE particles to the second PTFE particles ranges from 6:4 to 2:8.

4. The method for manufacturing a PTFE membrane of claim 2, wherein the mixing weight ratio of the first PTFE particles to the second PTFE particles ranges from 5:5 to 3:7.

5. The method for manufacturing a PTFE membrane of claim 2, wherein the heat of melting of the first PTFE particles, determined via DSC analysis under a heating rate condition of 10° C./min, ranges from 60 to 70 J/g, and the heat of melting of the second PTFE particles ranges from 50 to 60 J/g.

6. The method for manufacturing a PTFE membrane of claim 5, wherein the heat of melting of the first PTFE particles is in the range of 61 to 66 J/g, and the heat of melting of the second PTFE particles is in the range of 52 to 58 J/g.

7. The method for manufacturing a PTFE membrane of claim 2, wherein the melting temperature difference between the first and second PTFE particles is 2.0° C. or less.

8. The method for manufacturing a PTFE membrane of claim 2, wherein the melting temperature difference between the first and second PTFE particles is 1.0° C. or less.

9. The method for manufacturing a PTFE membrane of claim 1, wherein the additive comprises a hydrocarbon mixture solution with a concentration ratio of hydrocarbon having 9 to 11 carbon atoms to hydrocarbon having 10 to 13 carbon atoms within the range of 8:2 to 6:4.

10. The method for manufacturing a PTFE membrane of claim 9, wherein the additive is included in an amount of 10 to 30 wt % of the PTFE composition.

11. A PTFE membrane, manufactured by the manufacturing method of claim 1.

12. The PTFE membrane of claim 11, wherein the PTFE membrane has a pore size in the range of 0.2 to 0.4 μm and a porosity in the range of 70 to 90%.

13. A filter medium, comprising the PTFE membrane of claim 11 and an air-permeable support member laminated onto the PTFE membrane.

14. A filter pack, comprising the filter medium of claim 13, wherein the filter medium is pleated.

15. A filter unit, comprising the filter pack of claim 14 and a frame supporting a periphery of the filter pack.
